(19) United States
(12) Patent Application Publication
(10) Pub. No.: US 2022/0015033 A1
(43) Pub. Date: Jan. 13, 2022

(54) METHDO AND SYSTEM OF WIRELESS DEVICE POWER MANAGEMENT

(71) Applicant: MICRON ELECTRONICS LLC, Boca Raton, FL (US)

(72) Inventor: Jun XU, Boca Raton, FL (US)

(21) Appl. No.: 17/366,932

(22) Filed: Jul. 2, 2021

Related U.S. Application Data
(60) Provisional application No. 63/048,915, filed on Jul. 7, 2020.

(51) Int. Cl. H04W 52/02; H04W 4/90; H04W 4/38

(52) U.S. Cl. CPC H04W 52/0229; H04W 52/028; H04W 4/38; H04W 52/0277; H04W 4/90

(57) ABSTRACT

A power management method for a wireless device including a first circuit and a second circuit includes: iteratively detecting, by the second circuit, a wake-up event; in response to the wake-up event, connecting, by the second circuit, a power source to the first circuit and retrieving, by the first circuit, device states of the wireless device from a non-volatile storage; performing, by the first circuit, a normal operation of the wireless device according to the device states; iteratively detecting, by the wireless device, a power-down standby (PDS) event; and in response to the PDS event, saving, by the first circuit, the device states to the non-volatile storage and disconnecting, by the second circuit, the power source from the first circuit.

### CROSS-REFERENCE TO RELATED APPLICATION

This application claims the priority of U. S. Provisional Patent Application No. 63/048,915, filed on Jul. 7, 2020, the entire content of which is incorporated herein by reference.

### FIELD OF THE INVENTION

The present invention generally relates to wireless communication technologies and, more particularly, to a method and system of wireless device power management.

### BACKGROUND

In a modern society, wireless communication has already become a part of people's lives. People are expecting a ubiquitous availability of wireless communication in our environment, including places that are isolated, such as parking lots, parks and trails, campus, common areas, transit areas, etc., where emergency wireless communication equipment may need to be provided to keep the places and people visiting such places safe. Emergency wireless communication equipment is also used by every emergency personnel, such as fire fighters, search and rescuers, and other emergency responders.

Requirements for emergency wireless communication equipment may be different from ordinary wireless communication devices due to different usage patterns and conditions. Although emergency wireless communication equipment is expected to be used in harsh conditions with high reliability, similar to ordinary wireless phones, emergency wireless communication equipment may often be powered by batteries, and a battery standby life is critical for the emergency wireless communication equipment. Because the emergency wireless communication equipment is often used infrequently, a short standby battery life means more frequent maintenance and more likely being in a low battery condition when the emergency wireless communication equipment is actually used. Other wireless applications may often face similar problems.

Existing mobile power management technologies use various methods to try to limit device standby power consumption by introducing an idle mode where the mobile device is not actively used, which often relies on hardware inactivity timers or motion sensor to determine whether a device was idle. During the idle mode, a microcontroller in the device is disconnected from a power source. The device can only wake up from the idle mode by human intervention or according to preset wake-up parameters. On one hand, the device is unable to instantly respond and report random interruptions to device states between intervals of a preset wake-up time without direct human intervention (e.g., push a button.) On the other hand, to achieve the instant response and reporting, the microcontroller must stay power-on, thereby unable to achieve desired power saving.

The disclosed methods and systems are directed to solve one or more problems set forth above and other problems.

### BRIEF SUMMARY OF THE DISCLOSURE

One aspect of the present disclosure provides a power management method for a wireless device including a first circuit and a second circuit. The method includes: iteratively detecting, by the second circuit, a wake-up event; in response to the wake-up event, connecting, by the second circuit, a power source to the first circuit and retrieving, by the first circuit, device states of the wireless device from a non-volatile storage; performing, by the first circuit, a normal operation of the wireless device according to the device states; iteratively detecting, by the wireless device, a power-down standby (PDS) event; and in response to the PDS event, saving, by the first circuit, the device states to the non-volatile storage and disconnecting, by the second circuit, the power source from the first circuit.

Another aspect of the present disclosure provides a wireless device. The wireless device includes: a first circuit, configured to perform a normal operation of the wireless device, the first circuit including a processor, a memory coupled to the processor for storing program instructions and data, and a transmitter and a receiver for wireless communication through an antenna; and a second circuit, configured to manage a connection of a power source to the first circuit, the second circuit including at least a lower power processor and detecting at least one of a wake-up event or a power-down standby (PDS) event.

Other aspects of the present disclosure can be understood by those skilled in the art in light of the description, the claims, and the drawings of the present disclosure.

### BRIEF DESCRIPTION OF THE DRAWINGS

FIG. 1 illustrates an exemplary communication environment incorporating certain aspects of the disclosed embodiments;

FIG. 2 illustrates a block diagram of an exemplary wireless device consistent with the disclosed embodiments;

FIG. 3 illustrates a block diagram of an exemplary communication server consistent with the disclosed embodiments;

FIG. 4 illustrates an exemplary wireless device operational process consistent with the disclosed embodiments; and

FIG. 5 illustrates an exemplary communication server operational process consistent with the disclosed embodiments.

### DETAILED DESCRIPTION

Reference will now be made in detail to exemplary embodiments of the invention, which are illustrated in the accompanying drawings. Wherever possible, the same reference numbers will be used throughout the drawings to refer to the same or like parts.

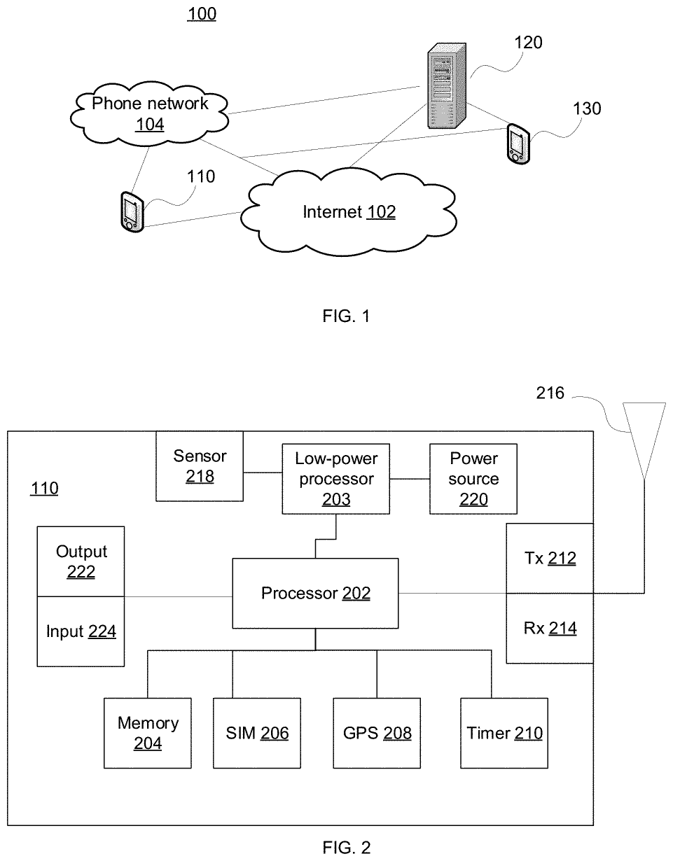

FIG. 1 illustrates an exemplary communication environment incorporating certain aspects of the disclosed embodiments. As shown in FIG. 1, communication environment 100 may include the Internet 102, a phone network 104, a wireless device 110, a communication server 120, and a communication device 130. Other components may be added and certain components may be removed without departing from the principles of the disclosed embodiments.

The Internet 102 may include any private and public computer networks interconnected using the standard transport control protocol/internet protocol (TCP/IP). Internet 102 may carry a large number of services over IP, such as the inter-linked hypertext documents of the World Wide Web (WWW) and electronic mail (or email). Internet 102 may connect a large number of websites. Further, Internet 102 may also carry voice-over IP (VOIP) services to enable voice or the like communications over Internet 102.

The phone network 104 may include any appropriate phone network such as a VOIP network, a public switched telephone network (PSTN), a cellular network, or any other telephone networks.

The wireless device 110 may include any appropriate communication device wirelessly communicate with the communication server 120. For example, the wireless device 110 may include a phone, a smart phone, a computer, a cell/mobile phone, a PDA, a tablet, or any customized communication devices used under various emergency conditions, etc. Although one wireless device 110 is shown in FIG. 1, any number and types of wireless devices may be included.

The communication server 120 may include one or more appropriate computer servers configured to provide various services to users through the Internet 102 and/or the phone network 104. For example, the communication server 120 may provide monitoring services (e.g., emergency monitoring, security monitoring, other types of monitoring, etc.), emergency response services, and/or emergency information access services, etc. Although one communication server 120 is included, any number of communication servers may be included.

The communication device 130 may include any appropriate device for communicating with the wireless device 110 directly through wireless channels or through wired communication path. The communication device 130 may also communicate with the communication server 120. Under certain circumstances, the communication device 130 and the communication server 120 may be used interchangeably.

The wireless device 110 may communicate with the communication server 120 wirelessly over the various networks. For example, the wireless device 110 may use any available cellular wireless standards, such as, GSM, GPRS, CDMA, WCDMA, 3G, 4G, LTE, and 5G, etc., 2-way radio, point-to-point, satellite, WIFI, and any other appropriate wireless communication protocols to communicate with the communication server 120.

Further, the wireless device 110 may communicate with the communication server 120 through a wireless service operator or without a wireless service operator. For example, the wireless device 110 may communicate with the communication server 120 using a wireless operator's short message service (SMS) to exchange information with the communication server 120 using SMS messages.

In a normal operation or a regular operation, the communication server 120 may maintain a database to store various information about associated wireless devices. The wireless device 110 may periodically report a device status, such as a battery status of the wireless device 110, to the communication server 120 according to pre-configured criteria. Further, the communication server 120 may configure the wireless device 110 remotely.

For example, the communication server 120 may set a status reporting period, or may set an emergency handling entity (e.g., a phone number, an IP address, a SIP number, an IMS URI, etc.) or an intended reporting entity for the wireless device 110 to communicate with. When an emergency event or another intended condition happens, the wireless device 110 may communicate with the emergency handling entity or the intended reporting entity automatically. The emergency handling entity may include the communication server 120 or a different entity, e.g., a 911 call center, etc. The intended reporting entity may include any appropriate devices or systems, such as a monitoring center, or a single user device (e.g., the communication device 130).

The communication environment 100 may be applied at various wireless communication systems and applications. For example, the communication environment 100 may include emergency wireless communication, asset tracking and monitoring, logistic, fleet management, and remote control, etc.

FIG. 2 illustrates a block diagram of an exemplary wireless device 110 consistent with the disclosed embodiments. As shown in FIG. 2, the wireless device 110 may include a processor 202, a low-power processor 203, a memory 204, a subscriber identification module (SIM) 206, a global positioning system (GPS) unit 208, a timer 210, a transmitter 212, a receiver 214, an antenna 216, a sensor 218, a power source 220, an output 222, and an input 224. Certain components may be omitted, and other components may be added.

The processor 202 may include any appropriate type of graphic processing unit (GPU), general-purpose microprocessor, digital signal processor (DSP) or microcontroller, and application specific integrated circuit (ASIC), etc. The processor 202 may also include a communication processor, such as a base-band processor for wireless communication, etc.

The processor 202 may execute sequences of computer program instructions to perform various processes associated with the wireless device 110. The computer program instructions may be stored and/or loaded in the memory 204 for execution by the processor 202.

The low-power processor 203 may include its own memory and interfaces to connect to the sensor 218. The low-power processor 203 may monitor a sensing signal from the sensor 218 and determine whether the sensing signal triggers a wake-up event. The wake-up event may or may not be triggered by a user input. In response to the wake-up event, the low-power processor 203 may connect the power source 220 to a first circuit of the wireless device 110. The first circuit may include at least the processor 202 and the memory 204 to perform the normal operation of the wireless device 110. The normal operation may or may not involve the user input. The first circuit may further include other components of the wireless device 110 that are required for performing the normal operation of the wireless device 110. In certain embodiments, the first circuit may also include one or more of the SIM 206, the GPS 208, the timer 210, the transmitter 212, the receiver 214, the antenna 216, the output 222, and the input 224. In certain embodiments, the processor 202 may have the lower-power processor 203 built in.

In certain embodiments, the low-power processor 203 may further include one or more of its own sensor, timer, and low-power machine-to-machine (M2M) communication mechanism for detecting the wake-up event. The circuit for detecting the wake-up event and connecting the power source to the first circuit after the wake-up event is detected is called a second circuit. The second circuit may include at least the low-power processor 203. The second circuit does not perform the normal operation of the wireless device 110. The second circuit manages connection of the power source 220 to the first circuit. The second circuit is always connected to the power source 220, but consumes substantially less power than the first circuit. In embodiments, the first and second circuits may include a plurality of separate circuits.

The memory 204 may include any appropriate memory units, such as random-access memory (RAM), read-only memory (ROM), flash memory, or any other type of memory or storage. The memory 204 may include a non-volatile memory (e.g., flash memory) for storing data as well as program execution states to preserve such information when power is not available. The non-volatile and other volatile memory may also be used for executing computer programs and storing run-time data, etc.

The SIM 206 may include any appropriate subscriber identification card to authenticate the wireless device 110 and for accessing a wireless network corresponding to the SIM 206. Although the SIM 206 is used in FIG. 2, any type of identification device may be used.

The GPS 208 may include any appropriate GPS device for providing location information about the wireless device 110. The timer 210 may provide various timer functions and associated logics for the wireless device 110.

Further, through the antenna 216, the transmitter 212 and the receiver 214 may provide wireless data communication transmission and receiving functions according to various wireless communication protocols. The sensor 218 may include any appropriate type of sensors for sensing one or more parameters such that a sensing signal may be provided to the processor 202 for further processing to determine the sensing parameters, or the sensing signal may be used directly to control certain logics of the wireless device 110.

The power source 220 may include any appropriate power source to provide an electrical power to the first circuit and the second circuit, such as the processor 202, the low-power processor 203, and other components of the wireless device 110. For example, the power source 220 may include AC power, DC power, solar power, and/or other power. In certain embodiments, the power source 220 may include one or more batteries, and the one or more batteries may be recharged using various types of external power sources. Further, the power source 220 may also include certain control logics for sending battery status to report to the processor 202 and/or to controlling/distributing battery output to the various components. A power-on switch (not shown) may be used to control the power to the various components of the wireless device 110, such as the processor 202, the SIM 206, the transmitter 212, and the receiver 214, etc.

The output 222 may be provided for a user of the wireless device 110 to receive information from the wireless device 110. For example, the output 222 may include any appropriate output device, such as a display, a speaker, or any other output devices.

The input 224 may be provided for the user of the wireless device 110 to input information into the wireless device 110. For example, the input 224 may include any appropriate input device, such as a keyboard, a microphone, a touch screen, or any other input devices. In certain embodiments, the input 224 may be a single button, which can be pressed by the user such that a communication message can be sent to a pre-configured emergency handling entity or a pre-configured intended reporting entity.

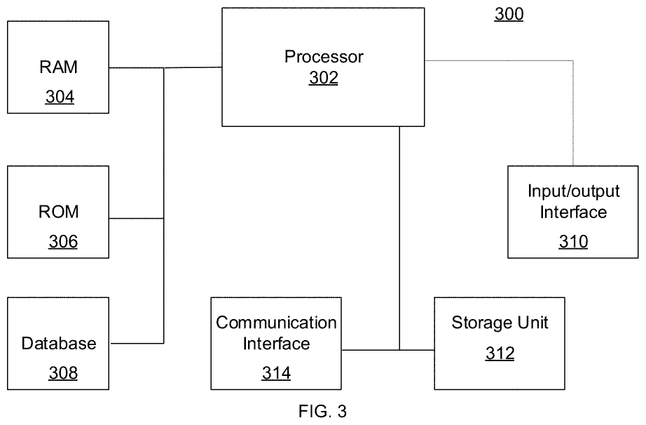

On the other hand, the communication server 120 may be implemented by any appropriate computer system. FIG. 3 illustrates a block diagram of an exemplary computing system 300 used to implement communication server 120.

As shown in FIG. 3, the computing system 300 may include a processor 302, a random-access memory (RAM) unit 304, a read-only memory (ROM) unit 306, a database 308, an input/output interface unit 310, a storage unit 312, and a communication interface 314. Other components may be added and certain devices may be removed without departing from the principles of the disclosed embodiments.

The processor 302 may include any appropriate type of graphic processing unit (GPU), general-purpose microprocessor, digital signal processor (DSP) or microcontroller, and application specific integrated circuit (ASIC), etc. The processor 302 may execute sequences of computer program instructions to perform various processes associated with the computing system 300. The computer program instructions may be loaded into the RAM 304 for execution by the processor 302 from the ROM 306.

The database 308 may include any appropriate commercial or customized database to be used by the computing system 300, and may also include query tools and other management software for managing the database 308. Further, the input/output interface 310 may be provided for a user or users to input information into the computing system 300 or for the user or users to receive information from the computing system 300. For example, the input/output interface 310 may include any appropriate input device, such as a remote control, a keyboard, a mouse, a microphone, a video camera or web-cam, an electronic tablet, voice communication devices, or any other optical or wireless input devices. The input/output interface 310 may also include any appropriate output device, such as a display, a speaker, or any other output devices.

The storage unit 312 may include any appropriate storage device to store information used by the computing system 300, such as a hard disk, a flash disk, an optical disk, a CR-ROM drive, a DVD or other type of mass storage media, or a network storage. Further, the communication interface 314 may provide communication connections such that the computing system 300 may be accessed remotely and/or communicate with other systems through computer networks or other communication networks via various communication protocols, such as TCP/IP, hyper text transfer protocol (HTTP), etc.

Returning to FIG. 1, during the normal operation, the wireless device 110 and the communication server 120 may perform certain operations to provide communication services with an enhanced power management capability. That is, as disclosed, the wireless device 110 and/or the communication server 120 may be configured to implement a power management mechanism to substantially prolong the battery standby time of the wireless device 110.

For example, in certain embodiments, the wireless device 110 may be configured to support a power-down standby (PDS) mode as part of the power management for the wireless device 110. In the PDS mode, most processing elements or a first circuit of the wireless device 110 are powered down while a low-power circuit or a second circuit of the wireless device 110 stays on to manage connection of the power source 220 to the first circuit. That is, in the PDS mode, the first circuit including the processor 202, the transmitter 212, the receiver 214, the antenna 216, the memory 204, the SIM 206, the GPS 208, etc., and other processing components is turned off (i.e., the wireless device 110 is substantially turned off), and only the second circuit is provided with power for controlling a power-on switch (not shown) of the power source 220. The power-on switch may be configured to connect with the first circuit such that the power-on switch can be turned off to stop the power to the first circuit or can be turned on to provide power to the turned-off first circuit from power source 220 under the control of the second circuit. The second circuit is always connected to the power source and is never turned off.

The second circuit may include any appropriate types of devices capable of triggering a wake-up event for the power-on switch to connect the power 220 source to the first circuit of the wireless device 110.

For example, the second circuit may include a timer (e.g., the timer 210). The timer may be an internal timer of the low-power processor 203 or a discrete timer chip or device configured to generate a time-out signal when a preset timer value is reached. The timer may periodically generate the time-out signal based on the timer value.

The timer value (i.e., the initial value of the timer) may be configured via a particular software interface by the user of the wireless device 110. Alternatively, the timer value may be set up on the circuit board using a specific tool, such as by a jumper, a register, or other configuration means. A default value may be set for the timer value and changes may be made by the user through software, hardware, or both. In certain embodiments, the timer value may be set to tens of seconds, a few minutes, a few hours, or tens of hours.

Further, the time-out signal may be provided to the power-on switch to connect the power source 220 to the first circuit of the wireless device 110, such that the wireless device 110 can be powered on to perform the normal operation by the power source 220 when the timer times-out. The timer value may also be configured by the operator of the communication server 120 or by a user of the communication device 130 remotely.

The second circuit may include a sensor or sensors which sense conditions and parameters of the surroundings of the wireless device 110, such as a temperature sensor, a motion sensor, a tilt sensor, a humidity sensor, a light sensor, a pressure sensor, a gravity sensor, a magnetic sensor, a moisture sensor, an electrical field sensor, an impact sensor, a sound sensor, and different types of digital input/output (DIO) sensors, etc. A sensing signal may be provided to the power-on switch to connect the power source 220 to power on the first circuit of the wireless device 110.

The second circuit may also include an input device (e.g., the input 224) for direct human intervention, such as a physical push button or a human-voice activated switch. The output signal of the input device may then be provided to the power-on switch to power on the first circuit of the wireless device 110.

More particularly, the direct human intervention may also be used for the user of the wireless device 110 to send out emergency messages or any other type messages to a pre-configured emergency handling entity or any intended reporting entity. For example, the user may press a single button, which generates an output signal to turn on the power-on switch, which then connects the power source 220 to the first circuit of the wireless device 110 and, at the same time, the output signal may also indicate that an emergency message (such as a 911 call or an emergency SMS message) or an intended message needs to be sent out automatically without further user intervention after the first circuit of the wireless device 110 is powered on.

That is, by a single pressing on the input device (e.g., a physical button), the first circuit of the wireless device 110 is brought back from the PDS mode and a message is automatically sent out after the power source 220 is connected to the first circuit of the wireless device 110. The second circuit may include another suitable component to implement such one-trigger mechanism.

Optionally or additionally, the wireless device 110 may be controlled by another device (not shown) over a machine-to-machine (M2M) communication interface. The second circuit may include an M2M communication device such that a control signal or message from an external device based on wired or wireless communication channels via WIFI, Zigbee, RFID, Bluetooth, Mbus, etc., can be used to control the power-on switch and/or indicate an emergency event or a reporting event for sending an emergency message or a reporting message to the pre-configured emergency handling entity or intended reporting entity. Because such short-range wireless device consumes little power, the battery standby time can be improved.

In certain embodiments, the wake-up event includes one or more of the sensing signal generated by the sensor 218, the time-out signal of the timer 210, an input signal of the input 224, and the control signal from the external device.

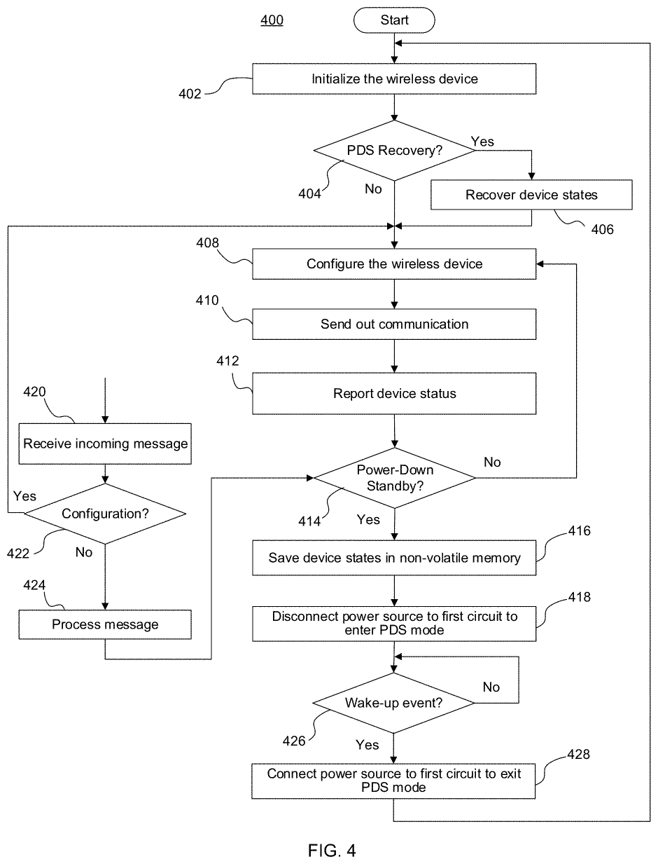

FIG. 4 illustrates an exemplary operational process 400 performed by the wireless device 110 (e.g., the processor 202 of the wireless device 110) consistent with the disclosed embodiments.

As shown in FIG. 4, when the wireless device 110 is power-on, various components of the wireless device 110 are initialized (402). For example, the wireless device 110 may run self-test or other processes to initialize hardware components and software components. Further, because the first circuit of the wireless device 110 may be powered back or recovering from the PDS mode, the wireless device 110 may determine whether the wireless device 110 is in a PDS recovery mode (404).

The wireless device 110 may check certain indicator, such as a register, a memory location, or any other device that stores the PDS mode. If the wireless device 110 determines that the first circuit of the wireless device 110 is recovering from the PDS mode (404; Yes), the wireless device 110 may recover all device states of the wireless device 110 (406). The device states include data describing the wireless device 110 in the normal operation mode.

That is, before the first circuit of the wireless device 110 enters the PDS mode, the wireless device 110 may save all the device states in a non-volatile memory. During the PDS recovery mode, the wireless device 110 may obtain all the device states from the non-volatile memory. The wireless device 110 uses the device states to resume the normal operation mode.

If the wireless device 110 determines that the first circuit of the wireless device 110 is not recovering from the PDS mode (404; No), or after the wireless device 110 recovers all the device states, the wireless device 110 may configure itself such that the wireless device 110 may be ready for the normal operation (408).

Further, if the PDS recovery is caused by a user input for sending out a communication message after recovery (e.g., by pressing the single emergency button on the wireless device 110), the wireless device 110 may send out an emergency communication message or an intended message to the pre-configured emergency handling entity or intended reporting entity (410). For example, the wireless device 110 may call the 911 call center number, may call the phone number configured to receive the communication, or may send the SMS message to the communication server 120, etc.

In addition, the wireless device 110 may report the device status to the communication server 120 (412). For example, the wireless device 110 may detect status and/or statistics of certain components of the wireless device 110, such as battery status, communication device status, etc.

In certain embodiments, the wireless device 110 may report a battery level periodically to the communication server 120 such that the communication server 120 can know that the wireless device 110 is active and when to recharge the battery of the wireless device 110. That is, after switching back to the normal operation mode, the wireless device 110 may detect the battery level at a user defined time period. For instance, the wireless device 110 may recover from the PDS mode every 24 hours to detect the battery level and send or update to the communication server 120.

During an emergency operation, the user of the wireless device 110 may start an emergency communication message by inputting a simple indication for an emergency event such that the emergency communication message can be automatically initiated. For example, the user may press the push button to send out the emergency communication message automatically without any further input. The emergency communication message is sent out to the pre-configured emergency handling entity after the emergency wireless device receives the input signal indicating such emergency event. That is, the user may press the push button to send out the emergency communication message when the wireless device 110 is in the normal operation mode, or may press the push button to recover from the PDS mode and send out the emergency communication message automatically at the same time without further input when the wireless device 110 is in the PDS mode.

During other operations, the user may also send a message to the pre-configured intended reporting entity by pressing the push button or by pressing a soft button. The intended reporting entity may include a phone number, an IP address, or any other address to receive the message.

Further, during the normal operation, the wireless device 110 may determine whether to enter the PDS mode (414; Yes). The wireless device 110 (e.g., software programs running on the wireless device 110) may detect whether the first circuit of the wireless device is idle, e.g., whether any application is running.

If the wireless device 110 determines that the PDS mode should not be entered (414; No), the wireless device 110 may continue the normal operation, such as configuring the device if needed, sending/receiving communication if needed, and reporting the device status periodically, etc.

On the other hand, if the wireless device 110 determines that the PDS mode should be entered (414; Yes), the wireless device 110 may save the device states into the non-volatile memory (416). After the device states are stored, the wireless device 110 may enter the PDS mode. For example, the second circuit of the wireless device 110 may shut down the first circuit by disconnecting the power-on switch with or without the user input such that the power source 220 is not providing power to the first circuit of the wireless device 110.

Additionally, during the normal operation, the wireless device 110 may receive incoming communication (420). For example, the wireless device 110 may receive an incoming call or a message from an external phone or may receive an SMS message from the communication server 120 or from an external device via an M2M communication device or interface.

After receiving the message, the wireless device 110 may determine a type of the message and further determine whether the message is a configuration message (422). That is, the wireless device 110 determines whether the message is sent by the communication server 120 to configure certain parameters on the wireless device 110.

For example, the configuration message may change the time period in which the wireless device 110 reports the device status to the communication server 120, set a wake-up timer value, or change the emergency handling entity to which the wireless device 110 may send its emergency communication message or the intended reporting entity to which the wireless device 110 may send other communication message, such as a tracking message, an event message, a location message, a status message, a control message, etc.

If the wireless device 110 determines that the message is the configuration message (422; Yes), the wireless device 110 may perform the configuration based on the configuration message (408). For instance, the wireless device 110 may configure the timer value for waking up from the PDS mode, the time period for reporting the device status, etc.

If the wireless device 110 determines that the message is not the configuration message (422; No), the wireless device 110 may further process the incoming message (424). For example, the wireless device 110 may establish a communication with the calling party or the SMS sender. Other processing may also be performed. For example, the incoming message may be a command to be executed by the wireless device 110, the wireless device 110 may execute the command accordingly and may further send back response to the sender (e.g., the communication server 120).

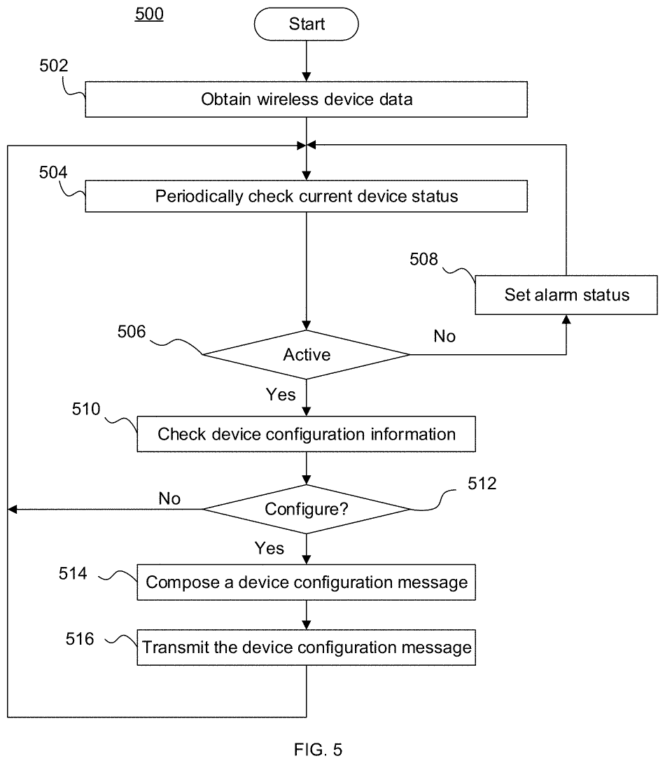

FIG. 5 illustrates an operation process 500 performed by the communication server 120 to facilitate the power management mechanism.

As shown in FIG. 5, the communication server 120 may obtain information of all wireless devices under its control (502). The communication server 120 may maintain a database of device data about the wireless devices that are managed by the communication server 120.

The communication server 120 may also periodically check a current device status (504). For example, the communication server 120 may check whether any status report is received from a particular wireless device within a predetermined time period. This predetermined time period may correspond to the time period for the wireless device to report the device status, such that the wireless device is able to report the device status (under normal operational condition) to the communication server 120 within the predetermined time period.

Further, based on the device status, the communication server 120 may determine whether the wireless device is active (506). The communication server 120 may determine whether the wireless device is active based on the device status. If the communication server 120 determines that the wireless device is not active (506; No), the communication server 120 may set an alarm status for the wireless device (508). For example, an alarm message may be sent to an operator or the user of the wireless device to notify the alarm status. More specifically, if the battery level is below a battery level threshold, a battery low message may be sent to the user of the wireless device to remind the user to recharge the battery.

On the other hand, if the communication server 120 determines that the wireless device is active (506; Yes), the communication server 120 may check the device configuration information (510) and may determine whether the wireless device needs to be configured (512). The communication server 120 may configure the wireless device with a different emergency handling entity, a different intended reporting entity, a different time period for reporting the device status, a different battery level threshold for recharging, etc.

If the wireless device does not need to be configured (512; No), the communication server 120 may continue the operation process. If the communication server 120 determines that the wireless device needs to be configured (512; Yes), the communication server 120 may compose a device configuration message (514) and may also transmit the device configuration message to the corresponding wireless device (516). The operation process may continue to provide monitoring and configuring functions to facilitate the PDS-based power management mechanism on the wireless device.

The disclosed system and method may be used in various wireless communication applications, including emergency wireless device applications, asset tracking and monitoring applications, logistic applications, fleet management applications, remote control applications, etc. Any wireless communication equipment may benefit from the enhanced power-down standby mode and related communication methods.

By using the disclosed system and method, the first circuit of the wireless device including the processing elements for the normal operation of the wireless device is completely disconnected from the power source and the wireless device enters the PDS mode while the second circuit of the wireless device including the processing elements for the power management is always connected to the power source. The first circuit of the wireless device is then powered-on by the second circuit of the wireless device, through certain “wake-up” mechanisms, to perform certain activities and, upon completion, returns to the PDS mode. Thus, when the wireless device is not performing any activity, a significantly less amount of battery power is used, and the battery connects to the first circuit of the wireless device only when the wireless device is “woke up.” The wireless device can remain in the PDS mode for weeks or months without recharging the battery, whereas the best traditional low power consumption mode can last only a few days or a couple of weeks.

Other applications, advantages, alternations, modifications, or equivalents to the disclosed embodiments are obvious to those skilled in the art.

What is claimed is:

1. A power management method for a wireless device, the wireless device including a first circuit and a second circuit, the method comprising:
iteratively detecting, by the second circuit, a wake-up event;
in response to the wake-up event, connecting, by the second circuit, a power source to the first circuit and retrieving, by the first circuit, device states of the wireless device from a non-volatile storage;
performing, by the first circuit, a normal operation of the wireless device according to the device states;
iteratively detecting, by the wireless device, a power-down standby (PDS) event; and
in response to the PDS event, saving, by the first circuit, the device states to the non-volatile storage and disconnecting, by the second circuit, the power source from the first circuit.

2. The method according to claim 1, wherein:
the second circuit is permanently connected to the power source and includes at least a lower power processor.

3. The method according to claim 1, wherein the wake-up event includes one or more of:
a sensing signal generated by a sensor;
a time-out signal of a timer;
an input signal of an input device; and
a control signal from an external device.

4. The method according to claim 3, wherein:
the sensor includes one or more of a temperature sensor, a motion sensor, a tilt sensor, a humidity sensor, a light sensor, a pressure sensor, a gravity sensor, a magnetic sensor, a moisture sensor, an electrical field sensor, an impact sensor, and a sound sensor.

5. The method according to claim 3, wherein:
the input signal of the input device simultaneously indicates to the first circuit to send out an emergency communication message automatically without further user input after the power source is connected to the first circuit.

6. The method according to claim 1, wherein performing the normal operation of the wireless device includes:
reporting a device status including at least a battery level of the wireless device to an external server based on configuration information on the wireless device;
receiving a user input to indicate an emergency event; and
sending an emergency communication message automatically to a pre-configured emergency handling entity without further user input.

7. The method according to claim 6, wherein performing the normal operation of the wireless device further includes:
receiving an incoming message;
determining whether the incoming message is a configuration message; and
in response to receiving the configuration message, configuring the wireless device according to the configuration message.

8. The method according to claim 1, wherein the PDS event includes:
the wireless device is idle for a preset time interval.

9. The method according to claim 1, wherein:
the power source is a battery.

10. A wireless device comprising:
a first circuit, configured to perform a normal operation of the wireless device, the first circuit including a processor, a memory coupled to the processor for storing program instructions and data, and a transmitter and a receiver for wireless communication through an antenna; and
a second circuit, configured to manage a connection of a power source to the first circuit, the second circuit including at least a lower power processor and detecting at least one of a wake-up event or a power-down standby (PDS) event.

11. The wireless device according to claim 10, wherein:
the second circuit is permanently connected to the power source;
after detecting the wake-up event, the second circuit connects the power source to the first circuit; and
after detecting the PDS event, the second circuit disconnects the power source from the first circuit.

12. The wireless device according to claim 11, wherein:
after the second circuit connects the power source to the first circuit, the first circuit retrieves device states from a non-volatile memory and performs a normal operation according to the device states; and
after detecting the PDS event and before the second circuit disconnects the power source from the first circuit; the first circuit saves the device states into the non-volatile memory.

13. The wireless device according to claim 10, wherein the wake-up event includes one or more of:
a sensing signal generated by a sensor;
a time-out signal of a timer;
an input signal of an input device; and
a control signal from an external device.

14. The wireless device according to claim 13, wherein:
the sensor includes one or more of a temperature sensor, a motion sensor, a tilt sensor, a humidity sensor, a light sensor, a pressure sensor, a gravity sensor, a magnetic sensor, a moisture sensor, an electrical field sensor, an impact sensor, and a sound sensor.

15. The wireless device according to claim 13, where:
the input signal of the input device simultaneously indicates to the first circuit to send out an emergency communication message automatically without further user input after the power source is connected to the first circuit.

16. The wireless device according to claim 10, when performing the normal operation of the wireless device, the processor of the first circuit is configured to:
report a device status including at least a battery level of the wireless device to an external server based on configuration information on the wireless device;
receive a user input to indicate an emergency event; and
send an emergency communication message automatically to a pre-configured emergency handling entity without further user input.

17. The wireless device according to claim 16, when performing the normal operation of the wireless device, the processor of the first circuit is further configured to:
receive an incoming message;
determine whether the incoming message is a configuration message; and
in response to receiving the configuration message, configure the wireless device according to the configuration message.

18. The wireless device according to claim 10, wherein the PDS event includes:
the wireless device is idle for a preset time interval.

19. The wireless device according to claim 10, wherein:
the power source is a battery.

20. The wireless device according to claim 10, wherein:
the first circuit includes a processor, a memory, and one or more of a subscriber identification module (SIM), a global positioning system (GPS) module, a timer, a transmitter, a receiver, an antenna, an output, and an input; and
the second circuit includes at least a low-power processor.
